(19) United States
(12) Patent Application Publication
(10) Pub. No.: US 2026/0299924 A1
(43) Pub. Date: Oct. 1, 2026

(54) SOFTWARE UPDATE SYSTEM, VEHICLE, SOFTWARE UPDATE DEVICE, AND SOFTWARE UPDATE METHOD

(71) Applicant: HONDA MOTOR CO., LTD., Tokyo (JP)

(72) Inventor: Yasumasa Kaitani, Tokyo (JP)

(21) Appl. No.: 19/564,674

(22) Filed: Mar. 12, 2026

(30) Foreign Application Priority Data
Mar. 27, 2025 (JP) 2025-054077

(51) Int. Cl. G06F 8/65

(52) U.S. Cl. CPC G06F 8/65

(57) ABSTRACT

A software update system including: a vehicle including an electronic control unit; and a server device capable of communicating with the vehicle, wherein the vehicle includes a software update unit that performs update of software of the electronic control unit, and wherein the software update unit transmits first information inquiring presence or absence of information related to the update of the software to the server device, receives second information including update software of the latest version from the server device, installs the update software included in the second information onto the electronic control unit, and, after installing the update software onto the electronic control unit, waits for transition to an activation process of the update software.

### INCORPORATION BY REFERENCE

The present application claims priority under 35 U.S.C. § 119 to Japanese Patent Application No. 2025-054077 filed on Mar. 27, 2025. The content of the application is incorporated herein by reference in its entirety.

### BACKGROUND OF THE INVENTION

### FIELD OF THE INVENTION

The present invention relates to a software update system, a vehicle, a software update device, and a software update method.

### Description of the Related Art

A technique for updating software of a vehicle has conventionally been known. For example, Japanese Patent Laid-Open No. 2023-071279 discloses a technique in which a control program of a vehicle is not updated to the latest version and the update is limited to a version with guaranteed operation.

Japanese Patent Laid-Open No. 2023-071279 can prevent software of a vehicle from being updated to software for which operation is not guaranteed. However, in the configuration of Japanese Patent Laid-Open No. 2023-071279, the update of software of the vehicle is limited to a version with guaranteed operation. Operation of the latest version will be eventually guaranteed and update to the latest version can be performed. However, a problem with the configuration of Japanese Patent Laid-Open No. 2023-071279 is that two times of software update, that is, update to the version with guaranteed operation and update to the latest version, occurs until the software of the vehicle is updated to the latest version, resulting in the large number of times of update of software.

An object of the present invention, which has been made in view of the above circumstances, is to prevent the software of the vehicle from being updated to software for which operation is not guaranteed while suppressing the number of times of update of the software from increasing.

### SUMMARY OF THE INVENTION

One aspect of the present invention is a software update system including: a vehicle including an electronic control unit; and a server device capable of communicating with the vehicle, wherein the vehicle includes a software update unit that performs update of software of the electronic control unit, and wherein the software update unit transmits first information inquiring presence or absence of information related to the update of the software to the server device, receives second information including update software of the latest version from the server device, installs the update software included in the second information onto the electronic control unit, and, after installing the update software onto the electronic control unit, waits for transition to an activation process of the update software.

According to one aspect of the present invention, it is possible to prevent the software of the vehicle from being updated to software for which operation is not guaranteed while suppressing the number of times of update of the software from increasing.

### BRIEF DESCRIPTION OF THE DRAWINGS

FIG. 1 is a diagram showing the structure of a software update system;

FIG. 2 is a diagram showing the configuration of a server device;

FIG. 3 is a diagram showing the configuration of a vehicle; and

FIG. 4 is a sequence diagram showing the operation of the software update device and the server device.

### DETAILED DESCRIPTION OF THE INVENTION

### 1. Configuration of Software Update System

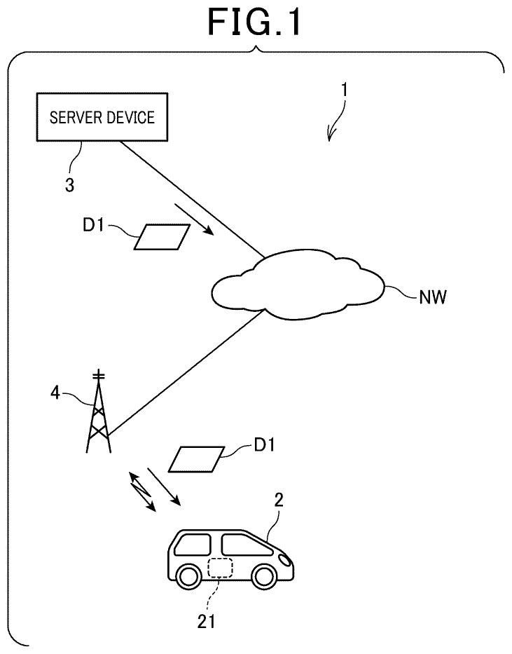

FIG. 1 is a diagram showing the configuration of a software update system 1.

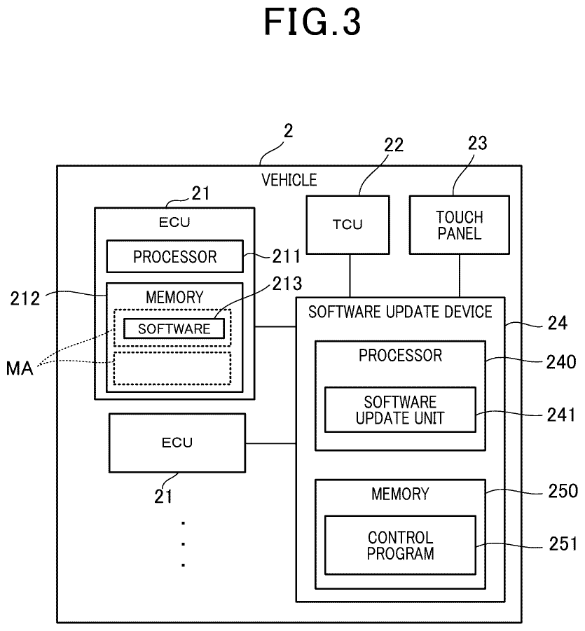

The software update system 1 includes a vehicle 2 and a server device 3 that provides software 213 (see FIG. 3) to be executed by an electronic control unit (ECU) 21 owned by the vehicle 2. The vehicle 2 and the server device 3 are communicatively connected to the vehicle 2 through a communication network NW. The vehicle 2 downloads software for update (hereinafter, with a reference sign “D1” attached thereto, expressed as update software D1) from the server device 3 and updates the software 213 provided in the ECU 21. That is, the software update system 1 enables over-the-air (OTA) update of the software 213 of the vehicle 2.

The ECU 21 is an example of “electronic control units”.

In the following description, the term software includes programs to be executed by a processor and data that is referenced, generated, updated, deleted, and the like in relation to the programs. The expression updating software refers to a process of replacing software to be executed by the processor with software of a newer version, which may be achieved in any specific way that includes addition, deletion, and overwriting of the software. Updating the software may also include processes of deleting some or all of the software to be executed by the processor, installing new software, and deleting, adding, and overwriting data used in the execution of software.

The vehicle 2 may be any of a four-wheeled vehicle, a two-wheeled vehicle, and other vehicles, or may be a heavy-duty vehicle, a commercial vehicle, a working vehicle, or the like. As an example, this embodiment describes a four-wheeled vehicle. The vehicle 2 is connected to the communication network NW by wireless communication via, for example, a base station 4 of cellular communication. The specific form of the communication network NW is not limited. For example, the communication network NW may include a cellular communication network, the Internet, a wide area network (WAN), a local area network (LAN), a public network, a provider device, a dedicated line, a base station, and the like.

The server device 3 is a computer connected to the communication network NW via a wired communication line or a wireless communication line and communicatively connected to the vehicle 2. The server device 3 transmits the update software D1 to the vehicle 2.

### 2. Configuration of Server Device

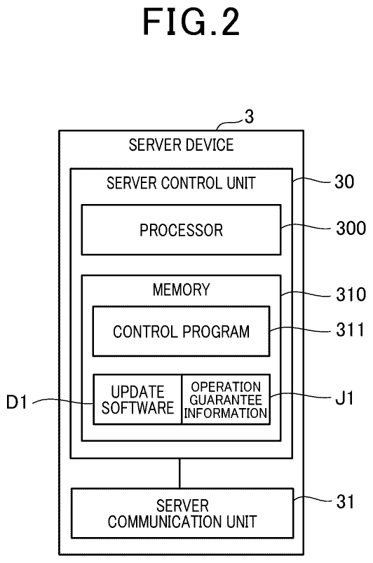

First, with reference to FIG. 2, the configuration of the server device 3 will be described.

FIG. 2 is a diagram showing the configuration of the server device 3.

The server device 3 includes a server control unit 30 and a server communication unit 31.

The server control unit 30 includes a processor 300, such as a central processing unit (CPU), a memory 310, and an interface circuit for connecting other devices and sensors. The server control unit 30 connects with the server communication unit 31. The server control unit 30 reads and executes a control program 311 stored in the memory 310 to perform various operations.

The memory 310 is a storage device storing programs and data. The memory 310 stores the control program 311, data to be processed by the processor 300, and the like. The memory 310 has a nonvolatile storage area. The memory 310 also has a volatile storage area and constitutes a working area for the processor 300. For example, the memory 310 is implemented by a read only memory (ROM) or a random access memory (RAM).

The memory 310 stores the update software D1 of the latest version and operation guarantee information J1 as a set. The operation guarantee information J1 is information indicating whether or not operation of the update software D1 of the latest version has been guaranteed. The information indicated by the operation guarantee information J1 is appropriately updated by the server control unit 30.

The server communication unit 31 includes hardware such as a communication circuit and communicates with the vehicle 2 as controlled by the server control unit 30.

### 3. Configuration of Vehicle

FIG. 3 is a diagram showing the configuration of the vehicle 2.

The vehicle 2 includes a plurality of ECUs 21, a telematics control unit (TCU) 22, a touch panel 23, and a software update device 24.

The ECUs 21 are electronic control devices that control equipment provided in the vehicle 2 and connect to the software update device 24. Examples of equipment controlled by the ECUs 21 include equipment that operates the wipers of the vehicle 2 and equipment that turns the lights of the vehicle 2 on and off. Each ECU 21 includes a processor 211, such as a CPU, and a memory 212, and controls the connected equipment by the processor 211 reading and executing the software 213 stored in the memory 212.

The memory 212 is a storage device storing programs and data. The memory 212 stores the software 213, data to be processed by the processor 211, and the like. The memory 212 is a double bank memory (so-called 2-sided ROM). The memory 212 has a volatile storage area and may constitute a working area for the processor 211.

The TCU 22 is a communication device that conforms to the communication standard of the vehicle 2 and communicates with devices other than the vehicle 2. The TCU 22 includes, for example, an antenna, a transmitter, a receiver, and the like, and communicates with the server device 3 as controlled by the software update device 24.

The touch panel 23, which is composed of a display and a touch sensor, accepts a touch operation and displays various types of information.

The software update device 24 is a device that updates the software 213 of the ECUs 21. The software update device 24 includes a processor 240, such as a CPU, a memory 250, and an interface circuit for connecting other devices and sensors.

The memory 250 is a storage device storing programs and data. The memory 250 stores the control program 251, data to be processed by the processor 240, and the like. The memory 250 has a nonvolatile storage area. The memory 250 also has a volatile storage area and constitutes a working area for the processor 240. For example, the memory 250 is implemented by a ROM and a RAM.

The processor 240 executes the control program 251 to thereby function as a software update unit 241.

The software update unit 241 updates the software 213 owned by the ECUs 21. The software update unit 241 performs a process of inquiring presence or absence of information related to update of the software 213, a process of downloading the update software D1, a process of installing the update software D1 onto the target ECU 21, and a process of causing the ECU 21 to perform the activation process of the update software D1.

### 4. Operation

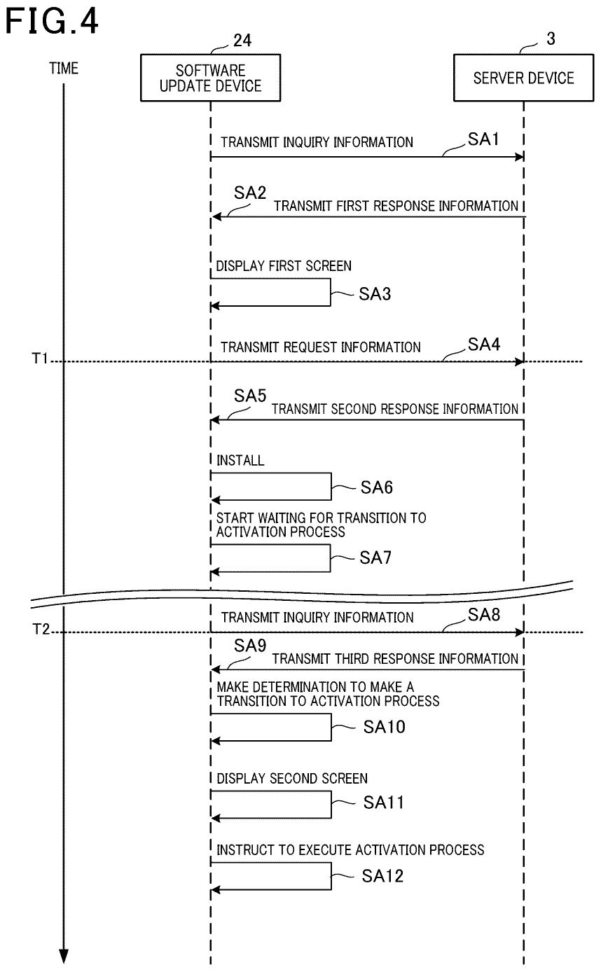

Next, with reference to FIG. 4, the operation related to the update of the software 213 of each unit of the software update system 1 will be described.

FIG. 4 is a sequence diagram showing the operation of the software update device 24 and the server device 3.

The software update unit 241 transmits inquiry information via the TCU 22 to the server device 3 (step SA1), the inquiry information inquiring presence or absence of information related to the update of the software 213.

The inquiry information is an example of “first information”.

Upon receiving the inquiry information via the server communication unit 31, the server control unit 30 transmits first response information to the vehicle 2 (step SA2).

The first response information is information indicating a response to the information transmission from the vehicle 2 and indicates presence or absence of information related to the update of the software 213.

The software update unit 241 receives the first response information via the TCU 22, and displays, in a case where the received first response information indicates presence of the update of the software 213, on the touch panel 23 a first screen that inquires the user of the vehicle 2 whether or not to perform update of the software 213 (step SA3). This inquiry to the user is made as required. For example, in the case of software update for the purpose of defect measures, the update may be performed without inquiring the user.

Upon instructed to perform update of the software 213 on the first screen, the software update unit 241 transmits, via the TCU 22, request information requesting the update software D1 to the server device 3 (step SA4).

In the example of FIG. 4, at timing T1 when the request information is transmitted, operation of the update software D1 of the latest version has not been guaranteed. In other words, at the timing T1, the operation guarantee information J1 indicates that operation has not been guaranteed.

Upon receiving the request information transmitted in step SA4, the server control unit 30 transmits second response information to the vehicle 2 (step SA5). The second response information is information indicating a response to the information transmission from the vehicle 2 and includes the update software D1 of the latest version.

The second response information is an example of “second information”.

Upon receiving the second information from the server device 3, in other words, upon downloading the update software D1 of the latest version from the server device 3, the software update unit 241 installs the downloaded update software D1 onto the target ECU 21 (step SA6).

To describe step SA6 in detail, the software update unit 241 transfers the update software D1 to the target ECU 21 and instructs the target ECU 21 to write the update software D1 to the memory 212.

As described above, the memory 212 provided in the ECUs 21 is a double bank memory. This enables the ECUs 21 to operate according to the software 213 stored in one storage area MA of the memory 212 while writing the update software D1 to the other storage area MA of the memory 212. Accordingly, the ECUs 21 can write the update software D1 to the memory 212 even when, for example, the vehicle 2 is traveling.

Subsequently, the software update unit 241 starts waiting for transition to the activation process of the update software D1 (step SA7).

In the example of FIG. 4, at timing T2, the software update unit 241 transmits inquiry information (step SA8). The timing T2 is the timing when a predetermined cycle including multiple days (for example, 28 days) has arrived since the inquiry information has been transmitted last time, or the timing when the user of vehicle 2 has made an input to update a predetermined application program to the touch panel 23.

The input to update a predetermined application program is an example of a “predetermined input”.

In the example of FIG. 4, at the timing T2 when the request information is transmitted, operation of the update software D1 of the latest version has been guaranteed. That is, at the timing T2, the operation guarantee information J1 indicates that the operation has been guaranteed.

Upon receiving the request information transmitted in step SA8, the server control unit 30 transmits third response information to the vehicle 2 (step SA9). The third response information is information indicating a response to the information transmission from the vehicle 2 and indicates permission of the activation process.

The third response information is an example of “third information”.

Upon receiving the third response information, the software update unit 241 determines whether or not to make a transition to the activation process of the update software D1 at the timing when the ignition power source of the vehicle 2 is turned off (step SA10).

Step SA10 will be described in detail. In the activation process, the use of the vehicle 2 is prohibited. Therefore, the activation process is performed by electric power supply from a battery (not shown). Accordingly, in a case where the software update unit 241 acquires the remaining electric power of the battery (not shown) and the acquired remaining electric power of the battery is equal to or larger than predetermined remaining electric power, the software update unit 241 makes affirmative determination in step SA10. This predetermined remaining electric power is appropriately predefined by a test, simulation, or the like in advance so as to prevent the remaining electric power of the battery from running out in the middle of the activation process.

In a case where the software update unit 241 has determined to make a transition to the activation process, the software update unit 241 displays on the touch panel 23 a second screen that inquires whether or not to start the update of the software (step SA11).

Upon instructed to start the update of the software 213 on the second screen, the software update unit 241 instructs the ECU 21 whose software 213 is to be updated to execute the activation process (step SA12).

Here, the activation process in the ECU 21 will be described.

Upon receiving the instruction to execute the activation process, the ECU 21 performs the activation process of the update software D1. The activation process of the update software D1 includes a process of setting, at the start-up of the ECU 21, start-up parameters of the ECU 21 so that the written update software D1 is loaded and control according to the update software D1 is started. For example, the activation process of the update software D1 includes a process of enabling, as a readout area, the storage area MA in which the update software D1 is written and disabling, as a readout area, the storage area MA in which the update software D1 is not written.

In the sequence shown in FIG. 4, in a case where the software update unit 241 receives the first response information from the server device 3, the software update unit 241 may skip the process of step SA3 and perform the process of step SA4. In the software update system 1, the processes of steps SA2, SA3, and SA4 may also be skipped. In other words, the software update unit 241 may be configured to receive the second response information on the basis of transmission of the inquiry information as a trigger.

### 5. Other Embodiments

The above-described embodiment merely shows an aspect thereof, and can be modified and applied as required.

In the above-described embodiment, 28 days are exemplified as the predetermined cycle for transmitting the first information. However, the predetermined cycle for transmitting the first information is not limited to 28 days, and may be any cycle including multiple days.

In the embodiment described above, as the “predetermined input”, an input to update a predetermined application program is exemplified. However, the “predetermined input” is not limited to the input to update the predetermined application program.

The processors 211, 240, and 300 may be composed of a plurality of processors or may be composed of a single processor. These processors may be hardware programmed to achieve the functional units described above. In such case, these processors are implemented by, for example, an application specific integrated circuit (ASIC) or a field programmable gate array (FPGA).

The internal configuration of the vehicle 2 shown in FIG. 3 is an example, and the specific implementation is not particularly limited. In other words, hardware individually corresponding to each unit is not necessarily implemented, and it is of course possible to adopt a configuration in which a single processor executes a program to thereby achieve the functions of respective units. Furthermore, a part of the functions achieved by software in the above-described embodiment may be provided as hardware, or a part of the functions achieved by the hardware may be achieved by the software.

The operational step units shown in FIG. 4 are obtained by dividing a process according to its main contents. The present invention is not limited by how to divide the process into units or how to name the divided units. The process may be further divided into more step units according to its contents. The process may also be divided so that one step unit includes more processes. The order of the steps may be changed as appropriate within a range that does not depart from the spirit of the present invention.

In a case where the system update method by the software update device 24 described above is implemented by using the processor 240, the program to be executed by the processor 240 can also be implemented in the form of a recording medium or a transmission medium that transmits the program. That is, the control program 251 can also be implemented by a portable information recording medium with the control program 251 recorded thereon. Examples of the information recording medium include magnetic recording media such as a hard disk, optical recording media such as a CD, and semiconductor storage devices such as a universal serial bus (USB) memory and a solid state drive (SSD), but other recording media can also be used.

### 6. Configurations Supported by the Above Embodiments

The above embodiments support the following configurations.

### Configuration 1

A software update system including: a vehicle including an electronic control unit; and a server device capable of communicating with the vehicle, wherein the vehicle includes a software update unit that performs update of software of the electronic control unit, and wherein the software update unit transmits first information inquiring presence or absence of information related to the update of the software to the server device, receives second information including update software of the latest version from the server device, installs the update software included in the second information onto the electronic control unit, and, after installing the update software onto the electronic control unit, waits for transition to an activation process of the update software.

According to the software update system of Configuration 1, the update software of the latest version is installed onto the electronic control unit, but updating the software of the electronic control unit to the latest version is waited. Since the software update system is configured to install the latest version, updating the software of the vehicle to the latest version only requires transitioning to the activation process. This eliminates the need to perform software update a plurality of times for updating the software of the vehicle to the latest version, so that it is possible to prevent the number of times of update of the software from increasing. Furthermore, even if the update software of the latest version is installed, transition to the activation process is waited, which makes it possible to prevent the software of the vehicle from being updated to software for which operation is not guaranteed.

### Configuration 2

The software update system according to Configuration 1, wherein, once operation of the update software has been guaranteed, the server device transmits third information for permitting the activation process to the vehicle, and wherein the software update unit transmits, after installing the update software onto the electronic control unit, the first information to the server device, and causes, in a case where the third information has been received from the server device as a response to the first information, the electronic control unit to perform the activation process.

According to the software update system of Configuration 2, in a case where the third information has been received from the server device, the software of the vehicle can be updated to software for which operation is guaranteed in order to perform the activation process.

### Configuration 3

The software update system according to Configuration 2, wherein the software update unit transmits the first information at timing when a user of the vehicle has made a predetermined input to the vehicle or at timing when a predetermined cycle including multiple days has arrived.

According to the software update system of Configuration 3, it is possible to suppress the first information from being transmitted with a high frequency. Therefore, it is possible to prevent the vehicle from downloading the update software with a high frequency. Accordingly, the frequency of communication between the vehicle and the server device can be suppressed.

### Configuration 4

A vehicle including an electronic control unit and capable of communicating with a server device, the vehicle including a software update unit that performs update of software of the electronic control unit, wherein the software update unit transmits first information inquiring presence or absence of information related to the update of the software to the server device, receives second information including update software from the server device, installs the update software included in the second information onto the electronic control unit, and, after installing the update software onto the electronic control unit, waits for transition to an activation process of the update software.

According to the vehicle of Configuration 4, the same effect as the software update system of Configuration 1 is achieved.

### Configuration 5

A software update device provided in a vehicle capable of communicating with a server device, the software update device including a software update unit that performs update of software of the electronic control unit owned by the vehicle, wherein the software update unit transmits first information inquiring presence or absence of information related to the update of the software to the server device, receives second information including update software from the server device, installs the update software included in the second information onto the electronic control unit, and, after installing the update software onto the electronic control unit, waits for transition to an activation process of the update software.

According to the software update device of Configuration 5, the same effect as the software update system of Configuration 1 is achieved.

### Configuration 6

A software update method for performing update of software of an electronic control unit owned by a vehicle capable of communicating with a server device, wherein, in the update of the software, the vehicle transmits first information inquiring presence or absence of information related to the update of the software to the server device, receives second information including update software from the server device, installs the update software included in the second information onto the electronic control unit, and, after installing the update software onto the electronic control unit, waits for transition to an activation process of the update software.

According to the software update method of Configuration 6, the same effect as the software update system of Configuration 1 is achieved.

### REFERENCE SIGNS LIST

1 software update system
2 vehicle
3 server device
4 base station
21 electronic control unit (ECU)
22 TCU
23 touch panel
24 software update device
30 server control unit
31 server communication unit
211 processor
212 memory
213 software
240 processor
241 software update unit
250 memory
251 control program
300 processor
310 memory
311 control program
D1 update software
J1 operation guarantee information
MA storage area
NW communication network

1. A software update system comprising:
a vehicle including an electronic control unit; and a server device capable of communicating with the vehicle,
wherein the vehicle includes
a software update unit that performs update of software of the electronic control unit, and
wherein the software update unit
transmits first information inquiring presence or absence of information related to the update of the software to the server device,
receives second information including update software of the latest version from the server device,
installs the update software included in the second information onto the electronic control unit, and,
after installing the update software onto the electronic control unit, waits for transition to an activation process of the update software.

2. The software update system according to claim 1,
wherein, once operation of the update software has been guaranteed, the server device transmits third information for permitting the activation process to the vehicle, and
wherein the software update unit transmits, after installing the update software onto the electronic control unit, the first information to the server device, and
causes, in a case where the third information has been received from the server device as a response to the first information, the electronic control unit to perform the activation process.

3. The software update system according to claim 2,
wherein the software update unit transmits the first information at timing when a user of the vehicle has made a predetermined input to the vehicle or at timing when a predetermined cycle including multiple days has arrived.

4. A vehicle including an electronic control unit and capable of communicating with a server device,
the vehicle comprising
a software update unit that performs update of software of the electronic control unit,
wherein the software update unit
transmits first information inquiring presence or absence of information related to the update of the software to the server device,
receives second information including update software from the server device,
installs the update software included in the second information onto the electronic control unit, and,
after installing the update software onto the electronic control unit, waits for transition to an activation process of the update software.

5. A software update device provided in a vehicle capable of communicating with a server device, the software update device comprising
a software update unit that performs update of software of the electronic control unit owned by the vehicle,
wherein the software update unit
transmits first information inquiring presence or absence of information related to the update of the software to the server device,
receives second information including update software from the server device,
installs the update software included in the second information onto the electronic control unit, and,
after installing the update software onto the electronic control unit, waits for transition to an activation process of the update software.

6. A software update method for performing update of software of an electronic control unit owned by a vehicle capable of communicating with a server device, wherein,
in the update of the software,
the vehicle
transmits first information inquiring presence or absence of information related to the update of the software to the server device,
receives second information including update software from the server device,
installs the update software included in the second information onto the electronic control unit, and,
after installing the update software onto the electronic control unit, waits for transition to an activation process of the update software.
